(19) United States
(12) Patent Application Publication
(10) Pub. No.: US 2015/0157944 A1
(43) Pub. Date: Jun. 11, 2015

(54) Software Application for Generating a Virtual Simulation for a Sport-Related Activity

(71) Applicant: Glenn I. Gottlieb, Los Gatos, CA (US)

(72) Inventor: Glenn I. Gottlieb, Los Gatos, CA (US)

(21) Appl. No.: 14/564,074

(22) Filed: Dec. 8, 2014

Related U.S. Application Data
(60) Provisional application No. 61/912,836, filed on Dec. 6, 2013.

(51) Int. Cl. A63F 13/812; A63F 13/25

(52) U.S. Cl. CPC A63F 13/812; A63F 13/25; A63B 2220/40; A63B 2220/833; A63B 2225/50; A63B 2220/53; A63B 2220/35; A63B 2220/31

(57) ABSTRACT

A system and a software method for generating a virtual simulation for a sport related activity based on real-world performance and input allows a user to assess their athletic performance during a sport-related activity. The system provides an external computing device and a sports ball that is implanted/integrated with internal sensors. The internal sensors collect of movement data for the sports ball during the sport-related activity. This movement data in conjunction with the ball specifications is used to generate a virtual movement model, a virtual representation of the sports ball and the associated physical and dynamic characteristics. A virtual environment is generated and adjusted by the environmental settings. Then, the virtual movement model is integrated within the virtual environment and the resultant is displayed and stored as a performance simulation on the external computing device. Data patterns are then derived from performance simulations collected over a period of time.

The current application is a non-provisional application and claims a priority to the U.S. provisional patent application Ser. No. 61/912,836 filed on Dec. 6, 2013. The current application is filed on Dec. 8, 2014 while Dec. 6, 2014 was on a weekend.

### FIELD OF THE INVENTION

The present invention relates generally to a system and method for enhancing athletic training and athletic oriented entertainment through a virtual environment simulation based on the real world performance data from the athlete. More specifically, the present invention is a sensor device, method, and system of utilizing sensors and wired/wireless communications in conjunction with sporting equipment in order to derive and analyze data from an athlete's practices and participation in the real world and project that data as actual performance into a virtual environment simulation of actual physical locations, electronically generated environments, and simulated environmental conditions.

### BACKGROUND OF THE INVENTION

The rapid development of electronic technology has led to the increasing integration of modern technology with traditional sporting equipment. Electronic technology is now used to evaluate and analyze multiple aspects of an athlete's performance in his or her sport, as well as in the development of athletic oriented entertainment. Sensor technology allows the integration of accelerometers, gyroscopes, Global Positioning System (GPS), and similar sensors with traditional sporting equipment such as balls, clubs, pucks, and bats. Cameras are capable of mapping an athlete's movements while wearable devices such as bracelets and watches are capable of performing similar functions. Sensors, cameras, and wearable devices are often paired with an external device and/or system that are capable of drawing and storing data from the athlete's practices and performance. While these technologies are successful in mapping an athlete's movements, there are generally very few implementations that take environmental conditions into account. An example of one such implementation are elliptical machines that change difficulty as it relates to virtual trails one could be on as those trails are projected onto a screen and viewed by the user. Additionally, there is generally no way to analyze an athlete's movements and practices in relation to the behavior of an object of action (i.e. a ball) utilizing the sensors defined above. This severely limits the usefulness of the sensor systems in assisting an athlete in improving their performance, and/or enhancing the entertainment value of athletic oriented entertainment. As a result, athletes cannot receive feedback regarding their actions and the impact on the behavior of an object of action within a virtualized environment of actual physical locations, electronically generated environments, and simulated environmental conditions. The present invention seeks to enhance and improve upon currently existing sensor technology and data analysis in relation to athletic training, simulation, and entertainment.

The present invention is a sensor device, method, and system for utilizing sensor and communication technology in conjunction with traditional sporting equipment in order to draw data from an athlete's practices and participation. The system of the present invention is capable of simulating external factors that may have an impact on the athlete's performance as well as taking these factors into consideration during data analysis. The data analysis performed by the system allows the athlete to receive real-time feedback regarding his or her performance as well as the impact of his or her actions on the behavior of an object of action. The sensor device of the present invention may be integrated directly into sporting equipment such as balls, clubs, and bats. Alternatively, the sensor device may be independent and able to be inserted into the sporting equipment, or worn by the athlete. Finally, the sensor device may be independent and able to be placed upon sporting equipment. The device may comprise one or more sensors such as accelerometers, gyroscopes, inertia measurement units, and GPS. The sensors are capable of mapping an object of action's movements and detecting impacts of an object of action with other objects and surfaces. During the course of athletic activity, the system of the present invention is capable of simulating environmental factors such as weather, topography, courses, fields, simulated movements of other players on the same team, and simulated movements of opposing players. These simulated factors are taken into consideration along with the athlete's performance in order to provide a realistic representation of the athlete's impact on the object of action. The data taken from the sensors is transmitted to an external device and/or system. The data transmission process may be wireless or wired. In a wired communication configuration, the sporting equipment and sensor device may be tethered directly to the external device and/or system. The electronic components of the sensor device draw power from an internal power system. In the preferred embodiment of the present invention, the internal power system comprises a piezoelectric generator or similar technology for converting movement to electrical energy. In alternative embodiments of the present invention, the electronic components of the sensor device may draw power from energy storage devices such as rechargeable batteries.

The data drawn from the sensors and transmitted to the external device and/or system is analyzed in order to provide an overview of the athlete's performance. The system provides analysis and feedback to the athlete regarding the impact of his or her performance on the behavior of the object of action. In addition to providing immediate real-time feedback to the athlete, the system is capable of storing data as well as compiling historical trends of the athlete's performance. For example, a golfer may view the results of his swings on the impacts, movements, and final resting positions of struck balls on a single simulated golf course over a period of time. This allows an athlete to monitor his or her progress over an extended period of time, and in this example enables the simulation of practice rounds and/or actual games utilizing an electronic version of any existing or theoretical golf course.

### BRIEF DESCRIPTION OF THE DRAWINGS

FIG. 1 is an illustration of the system portion of the present invention.

FIG. 2 is a flow chart of the general process of the present invention.

FIG. 3 is a flow chart depicting the steps of the general process that are executed by the external computing device.

FIG. 4 is a flow chart depicting the prerequisite steps before collecting spatial positioning and orientation data.

FIG. 5 is a flow chart depicting one possible arrangement of sensor devices that the inertial measurement sensors may contain and the following process for collecting raw data from those sensors.

FIG. 6 is a flow chart depicting another possible arrangement of sensor devices that the inertial measurement sensors may contain and the following process for collecting raw data from those sensors.

FIG. 7 is a flow chart depicting the steps required to collect and analyze raw data from the inertial measurement sensors.

FIG. 8 is a flow chart depicting the secondary steps required to generate a performance simulation based on environmental-independent data.

FIG. 9 is a flow chart depicting the secondary steps required to generate a performance simulation based on environmental-dependent data.

FIG. 10 is a flow chart depicting the process for accumulating a plurality of performance simulations.

FIG. 11 is a flow chart depicting the steps required to identify data patterns from the plurality of performance simulations.

FIG. 12 is a flow chart depicting the overall process for the game platform aspect of the present invention.

### DETAIL DESCRIPTIONS OF THE INVENTION

All illustrations of the drawings are for the purpose of describing selected versions of the present invention and are not intended to limit the scope of the present invention.

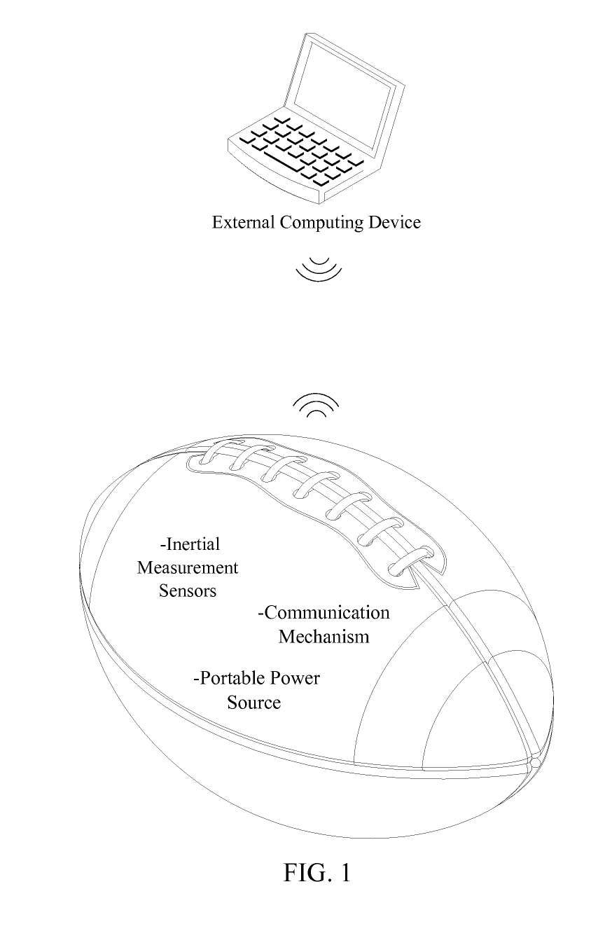

The present invention is a system and a software application to generate a virtual simulation for a sport-related activity. The virtual simulation allows a user to gather data on their performance during the sport-related activity for training and practice purposes, to track their progress through repetitions of the sport-related activity, participate in a simulation as part of a gaming platform, and/or to interact with other users as part of a gaming platform. The sport-related activity is a typical action done in a sport such as hitting a golf ball, throwing a football, hitting a tennis ball, or shooting a basketball. As can be seen in FIG. 1, the system components of the present invention are used to collect and analyze the data gathered during the sport-related activity. These system components include an external computing device and a sports ball with inertial measurement sensors. The inertial measurement sensors allow the present invention to gather spatial positioning and orientation data of the sports ball during a sport-related activity. For example, if the sports ball is a golf ball and if the sport-related activity is hitting the golf ball, then the inertial measurement sensors would gather spatial positioning and orientation data of the golf ball as the user is hitting the golf ball. The external computing device allows the present invention to generate the virtual simulation from the spatial positioning and orientation data of the sports ball and allows the present invention to implement interactive features for the user such as a performance analysis, a one-player virtualized game, and a gaming platform amongst other users.

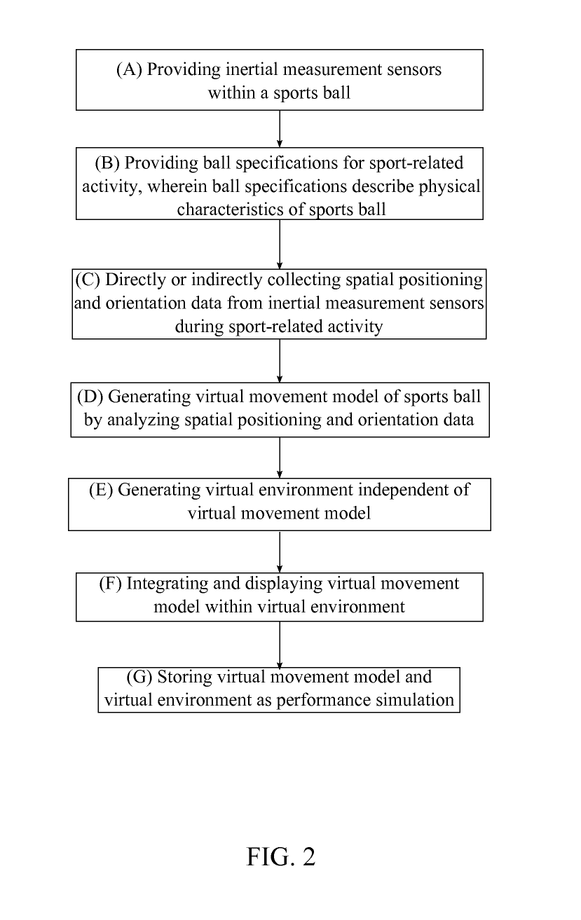

As can be seen in FIG. 2, the software application follows a general process that allows the present invention to generate the virtual simulation for the sport-related activity. The general process begins by being provided or receiving a set of ball specifications that describes the physical characteristics of the sports ball being used during the sport-related activity. The ball specifications can include, but is not limited to, the weight, the physical dimensions, and the aerodynamic design of the sports ball. Moreover, a sports ball can be, but are not limited to, a basketball, a soccer ball, a golf ball, a football, a hockey puck, and a tennis ball. In a different embodiment, alternative sport equipment may be used instead of the sports ball such as gloves, pads, bats, and clubs. The general process continues by directly or indirectly collecting spatial positioning and orientation data from the inertial measurement sensors during the sport-related activity. The spatial positioning and orientation data is used to fully describe the dynamic behavior of the sports ball during the sport-related activity. The raw data collected from the inertial measurement sensors is directly used as the spatial positioning and orientation data or is indirectly used to calculate the spatial positioning and orientation data. This depends on what kind of inertial measurement sensors are used to collect the raw data.

The general process carries on by generating a virtual movement model of the sports ball by the analyzing the spatial positioning and orientation data. The virtual movement model is a virtual representation of the necessary movement of the sports ball through the real-world environment. For example, if the sports ball is a golf ball and if the sport-related activity is hitting the golf ball, then the spatial positioning and orientation data that is collected during first few moments of hitting the golf ball can be used to compute the entire flight of the golf ball as the virtual movement model. The general process continues by generating a virtual environment that is independent of the virtual movement model. The virtual environment is a virtual representation of the physical, aesthetic, and other environmental conditions of a certain situation and/or place. The virtual environment can be used to depict a real world place, such as the Augusta National Golf Club, or a fictional place, such as an imaginary golf course created by the user. The software application then integrates and displays the virtual movement model within the virtual environment, which allows the user to view a virtual representation of the sports ball's movement during an instance of the sport-related activity. The information displayed to the user may include, but is not limited to, three dimensional positioning, velocity, acceleration, spin, external forces on the sports ball, trajectory, visual representation of the sport-related activity, and other similar information. For example, if the sports ball is a golf ball and if the sport-related activity is hitting the golf ball, then the present invention allows the user to view the virtual representation of the entire flight of the golf ball within a physical setting and scenery. The general process concludes by storing the virtual movement model and the virtual environment as one entity known as the performance simulation, which can be used in additional analysis and interactive features for the software application.

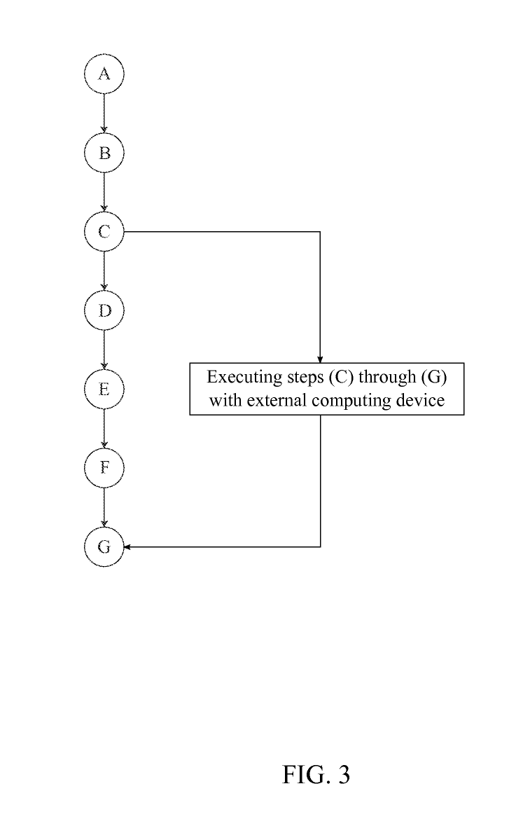

The system components of the present invention are configured to efficiently and effectively execute the general process of the software application. In addition to the inertial measurement sensors, system components that are positioned within the sports ball include a portable power source and a communication mechanism. The portable power source is used to power the inertial measurement sensors because the sports ball is moving during the sport-related activity, which would be difficult to power the inertial measure sensors with an external power source such as an electrical outlet. However, in some embodiments of the present invention, the portable power source can be replaced with an external power source. In the preferred embodiment, the portable power source is a piezoelectric generator, which is a device that converts translational motion into electricity. Consequently, the piezoelectric generator can convert the motion of the sports ball during the sport-related activity into electricity. In other embodiments, the portable power source can be rechargeable or disposable batteries. The communication mechanism is also powered by the portable power source and allows the inertial measurement sensors to transfer its raw data to the external computing device. The communication mechanism can be either a wireless or wired, and some wireless communication mechanisms can be, but are not limited to, Bluetooth, Wi-Fi, and other similar wireless technologies. Once the raw data from the inertial measurement sensors is communicated to the external computing device, the external computing device executes the remainder of the general process, which is illustrated in FIG. 3.

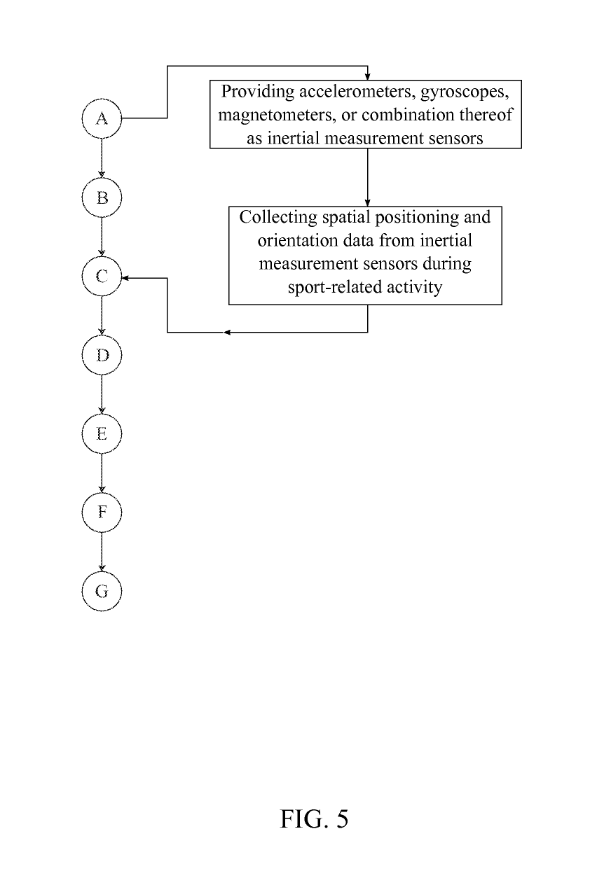

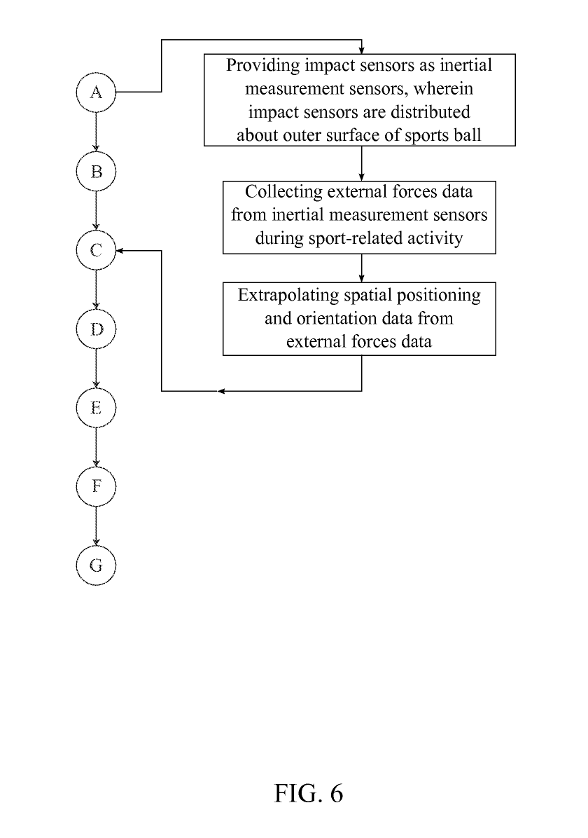

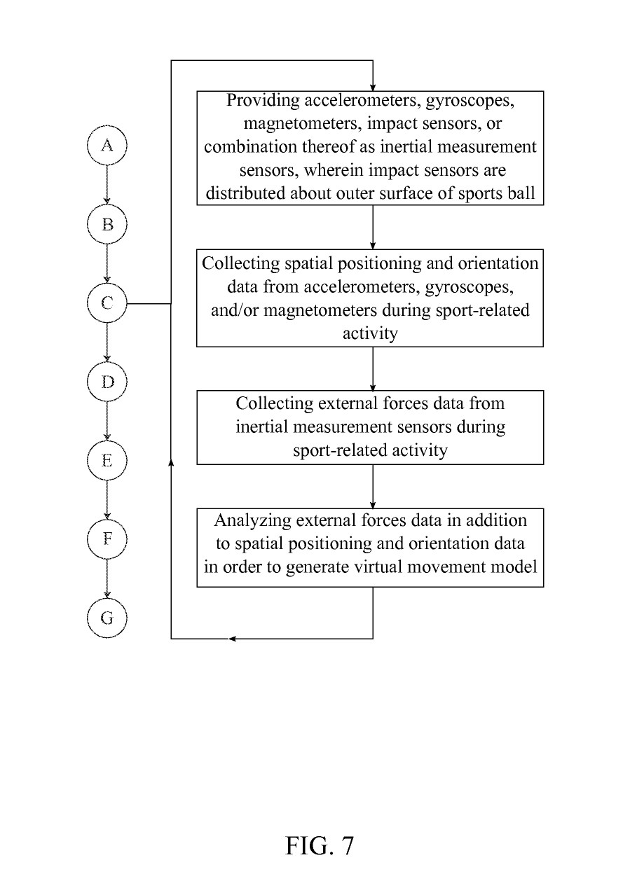

Different kinds and different combinations of sensors can be used as the inertial measurement sensors in order to gather different types of raw data. In one embodiment shown in FIG. 5, the inertial measurement sensors are a combination of accelerometers, gyroscopes, and magnetometers that are used to directly collect the spatial positioning and orientation data during the sport-related activity. Typically, the inertial measurement sensors include one accelerometer and one gyroscope for each of the X, Y, and Z directions and include a magnetometer to determine the direction of gravity. Alternatively, the inertial measurement sensors include a combination of those accelerometers and magnetometers with a single gyroscope component that is able to sense orientation in all three X, Y, and Z directions. In another embodiment shown in FIG. 6, the inertial measurement sensors are impact sensors that are distributed about the outer surface of the sports ball in order to measure force or pressure variations on the outer surface. Different types of impact sensors can be used with the present invention depending on the sport-related activity and the user's needs. One type of impact sensor is a force-sensing resistor that uses a material that naturally changes resistance in the presence of a force, and, therefore, measuring the voltage across the material is directly indicative of the pressure/force applied to the material. The software application would use the impact sensors to collect external forces data from the inertial measurement sensors during the sport-related activity. The external forces data describes the force or pressure variations on the outer surface of the sports ball, not the dynamic behavior of the sports ball, during the sport-related activity. However, the software application can then extrapolate the spatial positioning and orientation data from the external forces data. In another embodiment shown in FIG. 7, the inertial measurement sensors are a combination of accelerometers, gyroscopes, magnetometers, and impact sensors so that the raw data collected from the inertial measurement sensors includes the spatial positioning and orientation data from the accelerometers, gyroscopes, and/or magnetometers and the external forces data from the impact sensors. In this embodiment, the external forces data can be used to verify the spatial positioning and orientation data or can be used to enhance the accuracy and/or precision of the virtual movement model in order generate a more accurate virtual movement model of the sports ball.

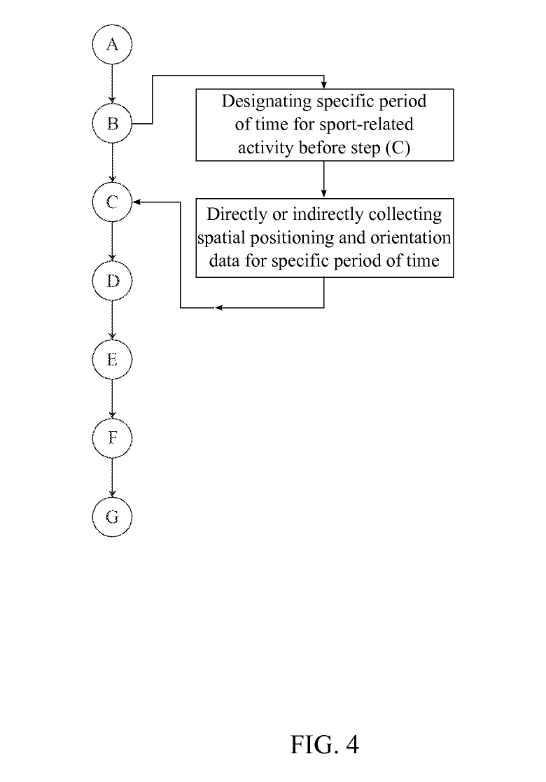

In some embodiments of the present invention, the software application needs to designate a specific period of time for the sport-related activity, which occurs before data is collect by the inertial movement sensors. As can be seen in FIG. 4, the specific period of time is used to describe the typical length of time that will be needed to complete the sport-related activity. For example, if the sports ball is a rugby ball and the sport-related activity is passing the rugby ball from one player to another player, then the specific length of time is defined from the beginning of the pass to the end of the pass. The software application designates the specific period of time in this example because the software application needs to separate the raw data collected during the sport-related activity and the raw data collected before and after the sport-related activity. For another example, if the sports ball is a golf ball and the sport-related activity is hitting the golf ball, then the specific period of time can be defined as the first few moments after the golf ball is hit by the golf ball. The spatial positioning and orientation data collected within these first few moments can be used by the software application to compute the entire flight of the golf ball for the virtual performance model. Such an example is important in the gaming platform feature of the software application because the golf ball containing the inertial measurement sensors will not be able to travel its entire flight within the confines of an indoor space. Thus, the software application collects the spatial positioning and orientation data for the specific period of time, which are those first few moments, instead of having to collect the spatial positioning and orientation data for the entire flight of the golf ball.

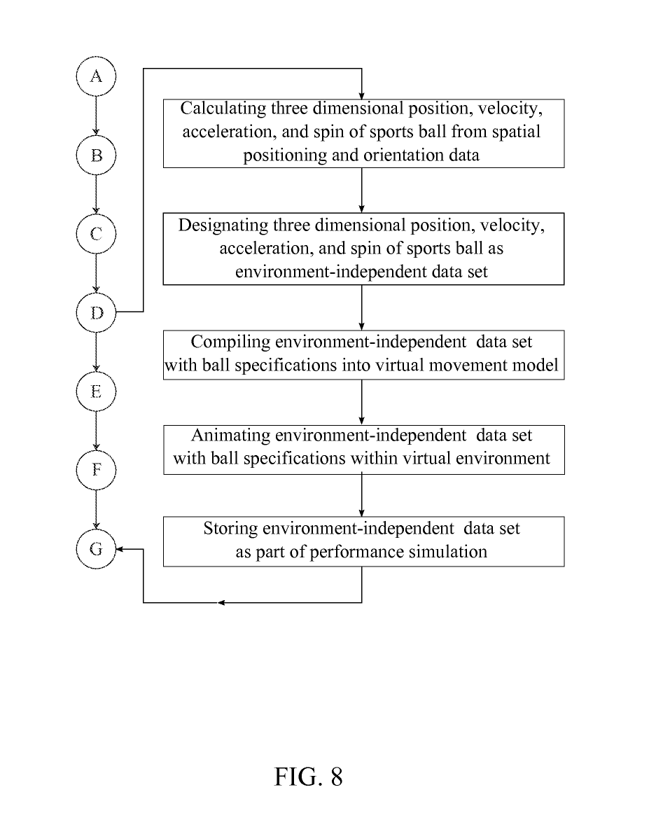

As can be seen in FIG. 8, the software application follows a secondary process to generate the virtual movement model. This secondary process begins by calculating the three dimensional position, the velocity, the acceleration, and the spin of the sports ball, which is kinematically derived from the spatial positioning and orientation data. The software application designates this derived information as an environment-independent data set, which describes the three dimensional position, the velocity, the acceleration, and the spin of the sports ball without accounting for environmental factors. The secondary process continues by compiling the environment-independent data set with the ball specifications into the virtual movement model, which describes the dynamic behavior and physical characteristics of the sports ball without showing any effects from environmental factors. The environment-independent data set and the ball specifications are animated by the software application when the virtual movement model is integrated and displayed within the virtual environment. In addition, the environment-independent data set is stored as a part of the performance simulations so that the environment-independent data can be referenced by other interactive features of the present invention.

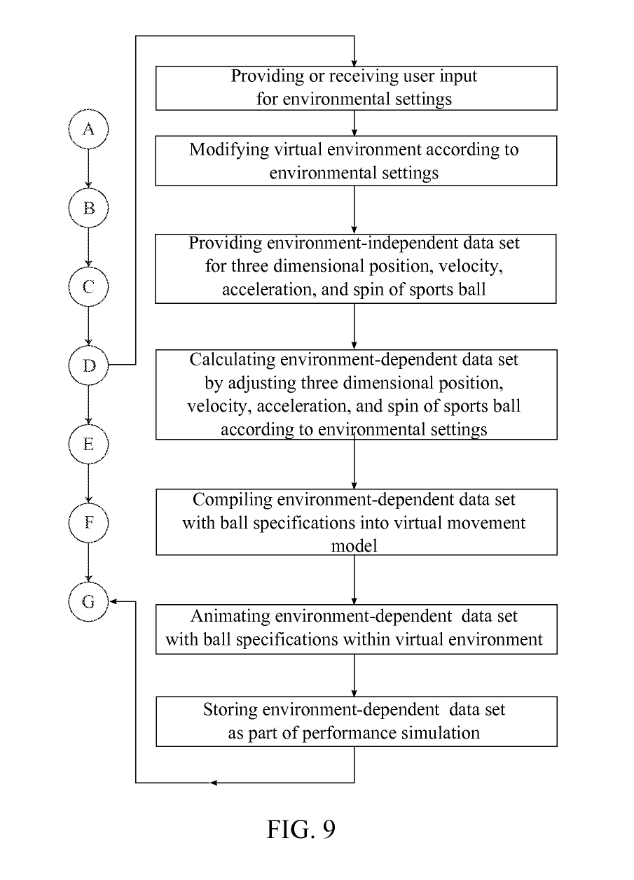

The software application also allows for environmental settings to be integrated into the performance simulation, which has a process flow shown in FIG. 9. The environmental settings are used to adjust various aspects of the virtual environment, which includes, but are not limited to, type of sport, type of sport-related action, weather characteristics, course or court conditions, team and/or opponent settings, and other pertinent information. The environment settings can either be provided by the software application as a default or be received by the software application as a user input. These environmental settings are then used to modify the virtual environment according to the default or the user input. Once the environment-independent data set is derived from the spatial positioning and orientation data, the software application is also able to calculate an environment-dependent data set by adjusting the three dimensional position, the velocity, the acceleration, and the spin of the sports ball according to those environmental settings. The software application designates this derived information as the environment-dependent data set because the three dimensional position, the velocity, the acceleration, and the spin of the sports ball are altered to account for the environmental factors. Moreover, the environment-dependent data set and the ball specifications can now be animated by the software application when the virtual movement model is integrated and displayed within the virtual environment, which generates a different performance simulation than the performance simulation created by the environment-independent data set. The software application can store the environment-independent data set in addition the environment-dependent data set as parts of the performance simulation so that both data sets can be referenced and compared against each other by other interactive features of the present invention.

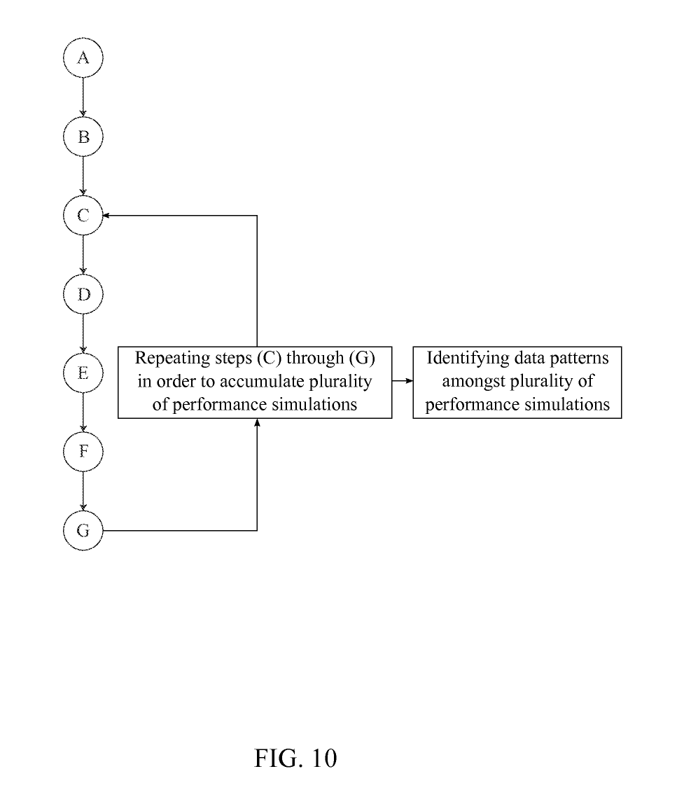

One interactive feature of the software application is analysis of data collected over a length of time. By repeating the general process of the software application, a plurality of performance simulations can be accumulated over a length of time and allow different analysis to be made by comparing them against each other. Consequently, the software application is able to identify data patterns amongst the plurality of performance simulations, which is shown in FIG. 10. By comparing the plurality of performance simulations against each other, trends may be derived which directly reflect the user's performance in relation to the sport-related activity. The plurality of performance simulations also allows for entertainment implementations such as running enough performance simulations to complete an 18-hole golf course for a single player and to track a user's performance on a single course. Continuing with the golfing example, data patterns that can be tracked over time in order implement additional features such as handicapping.

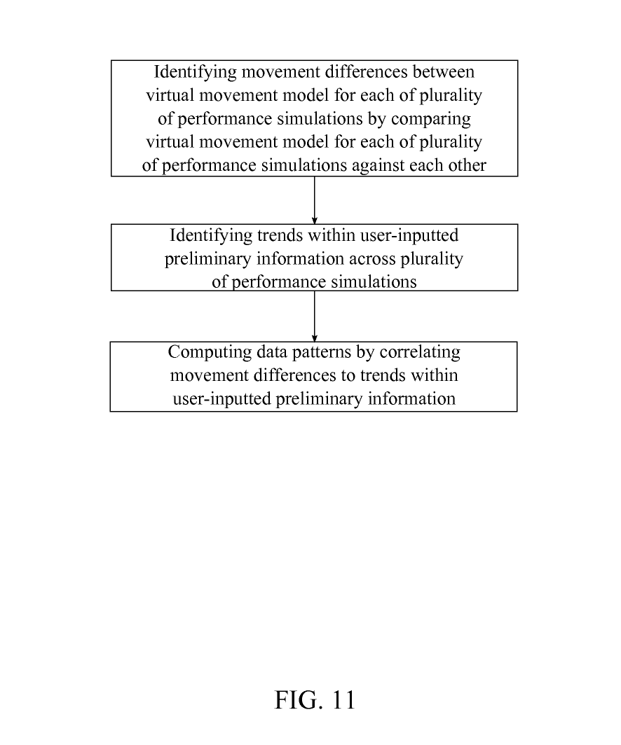

As can be seen in FIG. 11, various data patterns can be determined by analyzing the plurality of performance simulations. Data patterns show the user's progress over a length of time and can be a direct representation of the benefits and downsides to a training route or schedule. The software application follows a secondary process to determine these data patterns. The first step of this secondary process is to identify the movement differences between the virtual movement models for each of the performance simulations by comparing the virtual movement model for each of the performance simulations against each other. These movement differences include, but is not limited to, determining the mean, outliers, medium, accuracy, consistency, and other similar information between the plurality of performance simulations. Next, trends are identified within the user-inputted preliminary information across the plurality of simulations. The user-inputted preliminary information is any piece of information that the user uniquely input for an iteration of the general process. The software application is able to find trends by identifying pieces of user-inputted information that are consistent through all of the performance simulations. Finally, the data patterns are computed by correlating the movement differences to the trends within the user-inputted preliminary information. The data patterns obtained from this secondary process is a direct representation of the user's progress and performance through multiple iterations of the general process.

Another interactive feature of the software application is a gaming platform, which can be implemented by a single user or multiple users. If multiple users want to take part in the same gaming platform, the software application needs to have a player profile for each user. The player profile can be provided by the software application as a generic player profile or can be generated through user-inputted information. Thus, some of the user-inputted information can include, but not limited to, name, age, sex, height, weight, athletic level, and any other pertinent information. In addition, a user account can be created based on the information contained in the player profile and allows the user to access the software application's features and capabilities.

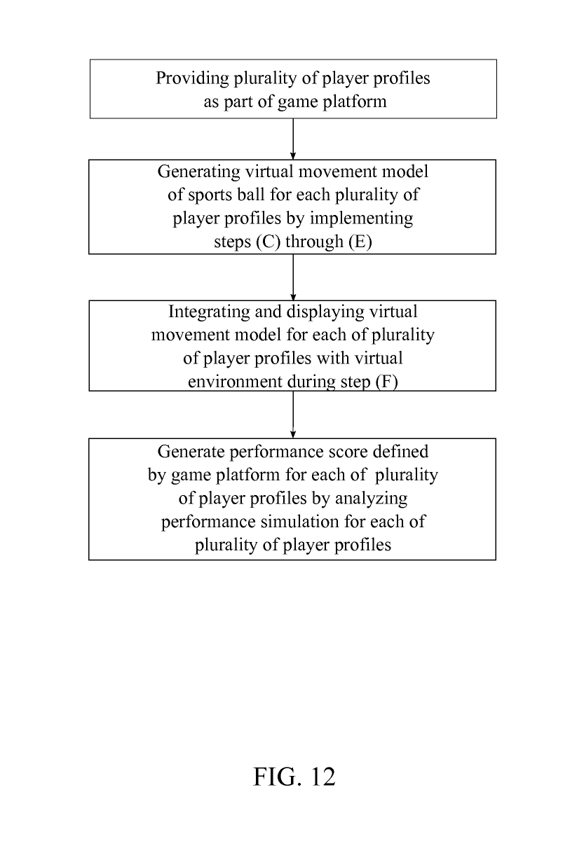

As can be seen in FIG. 12, the game platform for multiple users is provided with a plurality of player profiles. Steps of the general process are used to generate the virtual movement model for each player profile. This allows the software application to integrate and display the virtual movement model for each player profile into one single virtual environment so that each user can compare their performance of the sport-related activity against each other in the same virtual environment. The software application also generates a performance score defined by the game platform by analyzing the performance simulation of each player profile, which allows the multiple user to quantifiably compare with each other. Some examples of the game platform for multiple users is the software application enabling a virtual golfing tournament or a virtual home run derby.

One activity into which the present invention may be implemented in is golf. The internal components would be integrated/implanted into a golf ball. This would provide the external computing device with the spatial positioning and orientation data of the sports ball throughout its trajectory. Various information may be determined through the use of the present invention including, but not limited to, the angle at which a golf club strikes the ball, the force of the club striking the ball, ball spin, the flight path of the ball once struck, and the final resting location of the ball on a golf course that is simulated by the system. If desired by the user, the present invention may incorporate various external factors into the virtual environment, a simulated golf course, such as wind, rain, and hazards. This allows the present invention to take into consideration the user's performance and actions in striking a golf ball with the presence of external factors that may affect the dynamic behavior of the golf ball. Information such as trajectory, distance, external forces, club face direction, and other similar analysis may be used as part of a training regime for the user to track performance and progress. Historical data is kept to assist the user in understanding his/her personal trends over time. Also in regards to training, the simulation aspect of the present invention enables simulated play, driving ranges, skills development environments, etc in which the user can work on specific parts of his/her performance and is able to understand the impact of his/her habits/tendencies in striking the golf ball on the behavior of the golf ball.

Another activity that the present invention may simulate and be integrated into is football. The internal components would be integrated/implanted into or onto the football. Information that may be derived includes, but is not limited to, arm movement, arm angle, and speed of the thrown football. The present invention may generate a simulated field and game environment with various external factors such as wind, teammates, and defensive opponents. This provides an additional dimension for the athlete in his/her performance. This would require the user to adapt to various external factors in order to perform at a high level and improve overall. For example, a user simulating the position of a quarterback may need to be wary of an unpredictable defensive play simulated by the defensive opponents. The user may need to take the opponents into consideration while also maintaining awareness of the positioning of his/her teammates, for example, to complete a pass to a simulated receiver. The present invention allows the user to physically throw the football in order to simulate the pass. This also allows the user to simulate handing off the football to a simulated running back, for example, by turning to the left or right at the correct moment. Data gathered may include a compilation of the user's actions with statistics such as, but not limited to, historical arm movement, football speed, historical arm angle, incomplete passes, interceptions, receivers thrown to, open receivers missed, quarterback movement in and out of the pocket, and fumbles. In this manner, a comprehensive training environment can be created for the development of quarterbacks.

Another activity that the present invention may simulate and be integrated into is tennis. The internal components would be integrated/implanted into or onto the tennis ball. Data that may be determined from the present invention would include racquet swing force, ball spin, ball flight path once struck, and angle of the racquet at the moment of strike. In this application, the present invention can either be used physically on a tennis court (training session, or real match if desired), or utilized during a simulated tennis court and match environment with external factors such as the net coming into play, and may also simulate an opponent or a doubles partner and multiple opponents based on the user's needs. As a result, the user is required to adapt to the movements and actions of his or her opponent(s) and partner (if applicable). An example of training includes, but not limited to, data gathered during a training session, training match on physical tennis court, or within a simulated environment, the application comprises a compilation of statistics such as ball flight path once struck and the number of times that the athlete struck the ball into the net throughout the course of a simulated match, effectiveness, direction, and speed of serves, backhand shots, forehand shots, use of backspin, which shots and other relevant data. Real-time data provides instant feedback on a session, while historical data provides insight into trends and performance patterns of the user.

Another activity that the present invention may simulate and be integrated into is baseball. The internal components would be integrated/implanted into or onto the baseball. In this application, the user may serve the role of a pitcher in a simulated field and game environment or an environment such as a bullpen session. Part of the virtual environment could be a target strike zone to allow the user to practice his/her accuracy. An example of information gathered from this application includes, but not is not limited to, arm angle, pitch velocity, pitch type, flight path of a pitch, baseball spin, and location inside or outside the strike zone. Some environmental settings that could be incorporated into the virtual environment includes external factors such as field dimensions (i.e. for home run distances), an opposing batter, teammates (defenders), wind, and field lighting/shadows. Data gathered from a performance simulation could be used to determine number of hits, walks, hit batters, and runs given up. From a plurality of performance simulations, the athlete is also able to view the progression of his/her velocity and the effect of any changes in velocity on his/her performance. Historical data analysis may provide the user with information regarding his/her progression utilizing various pitch types as well as an extended overview of his or her velocity taking into account any days of rest and bullpens thrown between simulated games. An example of entertainment and gaming, includes, but not limited the use of the present invention as the basis for a baseball gaming experience where the user is actually the pitcher, and actively participates, versus using a controller. Utilizing similar technology as the present invention, the player could also be the batter within the game. The game could be local players and/or can be a multiplayer game.

Although the invention has been explained in relation to its preferred embodiment, it is to be understood that many other possible modifications and variations can be made without departing from the spirit and scope of the invention as hereinafter claimed.

What is claimed is:

1. A method of generating a virtual simulation for a sport-related activity, the method comprises the steps of:
(A) providing inertial measurement sensors within a sports ball;
(B) providing a ball specifications for a sport-related activity, wherein the ball specifications describe physical characteristics of the sports ball;
(C) directly or indirectly collecting spatial positioning and orientation data from the inertial measurement sensors during the sport-related activity;
(D) generating a virtual movement model of the sports ball by analyzing the spatial positioning and orientation data;
(E) generating a virtual environment independent of the virtual movement model;
(F) integrating and displaying the virtual movement model within the virtual environment; and
(G) storing the virtual movement model and the virtual environment as a performance simulation.

2. The method of generating a virtual simulation for a sport-related activity, wherein the inertial measurement sensors are physically implanted into the sports ball.

3. The method of generating a virtual simulation for a sport-related activity, wherein the inertial measurement sensors are physically integrated into the sports ball.

4. The method of generating a virtual simulation for a sport-related activity, the method as claimed in claim 1 comprises the steps of:
providing a portable power source integrated within the sports ball;
providing an external computing device;
powering the inertial measurement sensors with the portable power source during steps (C);
communicating raw data collected from the inertial measurement sensors to the external computing device; and
executing steps (C) through (G) with the external computing device.

5. The method of generating a virtual simulation for a sport-related activity, the method as claimed in claim 1 comprises the steps of:
designating a specific period of time for the sport-related activity before step (C); and
directly or indirectly collecting the spatial positioning and orientation data for the specific period of time.

6. The method of generating a virtual simulation for a sport-related activity, the method as claimed in claim 1 comprises the steps of:
providing accelerometers, gyroscopes, magnetometers, or a combination thereof as the inertial measurement sensors; and
collecting the spatial positioning and orientation data from the inertial measurement sensors during the sport-related activity.

7. The method of generating a virtual simulation for a sport-related activity, the method as claimed in claim 1 comprises the steps of:
providing impact sensors as the inertial measurement sensors, wherein the impact sensors are distributed about an outer surface of the sports ball;
collecting external forces data from the inertial measurement sensors during the sport-related activity; and
extrapolating the spatial positioning and orientation data from the external forces data.

8. The method of generating a virtual simulation for a sport-related activity, the method as claimed in claim 1 comprises the steps of:
providing accelerometers, gyroscopes, magnetometers, impact sensors, or a combination thereof as the inertial measurement sensors, wherein the impact sensors are distributed about an outer surface of the sports ball;
collecting the spatial positioning and orientation data from the accelerometers, the gyroscopes, and/or the magnetometers during the sport-related activity;
collecting external forces data from the inertial measurement sensors during the sport-related activity; and
analyzing the external forces data in addition to the spatial positioning and orientation data in order to generate the virtual movement model.

9. The method of generating a virtual simulation for a sport-related activity, the method as claimed in claim 1 comprises the steps of:
calculating three dimensional position, velocity, acceleration, and spin of the sports ball from the spatial positioning and orientation data;
designating the three dimensional position, the velocity, acceleration, and spin of the sports ball as an environment-independent data set;
compiling the environment-independent data set with the ball specifications into the virtual movement model;
animating the environment-independent data set with the ball specifications within the virtual environment; and
storing the environment-independent data set as part of the performance simulation.

10. The method of generating a virtual simulation for a sport-related activity, the method as claimed in claim 1 comprises the steps of:
providing or receiving user input for environmental settings; and
modifying the virtual environment according to the environmental settings.

11. The method of generating a virtual simulation for a sport-related activity, the method as claimed in claim 10 comprises the steps of:
providing an environment-independent data set for three dimensional position, velocity, acceleration, and spin of the sports ball;
calculating an environment-dependent data set by adjusting the three dimensional position, the velocity, the acceleration, and the spin of the sports ball according to the environmental settings;
compiling the environment-dependent data set with the ball specifications into the virtual movement model;
animating the environment-dependent data set with the ball specifications within the virtual environment; and
storing the environment-dependent data set as part of the performance simulation.

12. The method of generating a virtual simulation for a sport-related activity as claimed in claim 1 comprising:
repeating steps (C) through (G) in order to accumulate a plurality of performance simulations; and
identifying data patterns amongst the plurality of performance simulations.

13. The method of generating a virtual simulation for a sport-related activity as claimed in claim 12 comprising:
identifying movement differences between the virtual movement model for each of the plurality of performance simulations by comparing the virtual movement model for each of the plurality of performance simulations against each other;
identifying trends within user-inputted preliminary information across the plurality of performance simulations; and
computing the data patterns by correlating the movement differences to the trends within the user-inputted preliminary information.

14. The method of generating a virtual simulation for a sport-related activity as claimed in claim 1 comprising:
providing a plurality of player profiles as part of a game platform;
generating the virtual movement model of the sports ball for each of the plurality of player profiles by implementing steps (C) through (E);
integrating and displaying the virtual movement model for each of the plurality of player profiles with the virtual environment during step (F); and
generate a performance score defined by the game platform for each of the plurality of player profiles by analyzing the performance simulation for each of the plurality of player profiles.
